(19) United States
(12) Patent Application Publication
(10) Pub. No.: US 2017/0158520 A1
(43) Pub. Date: Jun. 8, 2017

(54) SYNTHESIS OF ALUMINOSILICATE ZEOLITES HAVING THE OFFRETITE STRUCTURE

(71) Applicant: Chevron U.S.A. Inc., San Ramon, CA (US)

(72) Inventors: Dan Xie, Richmond, CA (US); Tracy Margaret Davis, Novato, CA (US)

(21) Appl. No.: 14/959,633

(22) Filed: Dec. 4, 2015

(51) Int. Cl. C01B 39/48; B01J 37/00; B01J 29/70

(52) U.S. Cl. CPC C01B 39/48; B01J 29/70; B01J 37/0018

(57) ABSTRACT

A method is disclosed for making aluminosilicate zeolites having the offretite structure from amorphous sources of silica and alumina in the presence of benzyltrimethylammonium cations as a structure directing agent.

### TECHNICAL FIELD

This disclosure relates generally to a method for preparing aluminosilicate zeolites having the offretite structure from amorphous sources of silica and alumina using benzyltrimethylammonium cations as a structure directing agent.

### BACKGROUND

Molecular sieves are a commercially important class of crystalline materials. They have distinct crystal structures with ordered pore structures which are demonstrated by distinct X-ray diffraction patterns. The crystal structure defines cavities and pores which are characteristic of the different species. Molecular sieves such as zeolites have been used extensively to catalyze a number of chemical reactions in refinery and petrochemical reactions, and catalysis, adsorption, separation, and chromatography.

Offretite is a rare naturally occurring zeolite. The structure can be described by a sequence AABAAB . . . of 6-membered rings of tetrahedra. The International Zeolite Association (IZA) has assigned the three-letter code OFF to materials that have the same framework type as the natural zeolite offretite.

Great Britain Patent No. 1,188,043 discloses a synthetic offretite type aluminosilicate material and its synthesis in the presence of tetramethylammonium cations as a structure directing agent. The synthetic offretite type materials are reported to have SiO₂/Al₂O₃ mole ratios in the range of 5-10.

M. Itakura et al. (Mater. Res. Bull. 2010, 45, 646-650) report the synthesis of high-silica offretite by interzeolite conversion of faujasite zeolite in the presence of both benzyltrimethylammonium cations and alkali metal cations. However, offretite was not obtained from amorphous starting materials (amorphous SiO₂ and γ-Al₂O₃ or aluminum hydroxide).

It has now been found that aluminosilicate OFF framework type zeolites can be prepared from amorphous materials in the presence of benzyltrimethylammonium cations as a structure directing agent.

### SUMMARY

In one aspect, there is provided a method for preparing an aluminosilicate OFF framework type zeolite by: (a) preparing a reaction mixture containing: (1) an amorphous silica source; (2) an amorphous alumina source; (3) a source of potassium; (4) hydroxide ions; (5) benzyltrimethylammonium cations; (6) optionally, an auxiliary organic nitrogen-containing structure directing agent; (7) water; and (b) subjecting the reaction mixture to crystallization condition sufficient to form crystals of the zeolite.

In its as-synthesized and anhydrous form, the aluminosilicate OFF framework type zeolites prepared by the method disclosed herein have a chemical composition comprising the following molar relationship:

m(Q+A):Al₂O₃:(n)SiO₂

wherein 0<m≦0.2; Q represents benzyltrimethylammonium cations, and Q>0; A represents an auxiliary organic nitrogen-containing structure directing agent, and A≧0; and n has a value of from 10 to 16.

### BRIEF DESCRIPTION OF THE DRAWINGS

FIG. 1 is a powder X-ray diffraction (XRD) pattern of the as-synthesized zeolite prepared in Example 1.

FIG. 2 is a Scanning Electron Micrograph (SEM) image of the as-synthesized zeolite prepared in Example 1.

FIG. 3 shows a comparison of the powder XRD patterns of the as-synthesized zeolites prepared in Examples 2-5 to the characteristic XRD lines observed for offretite.

### DETAILED DESCRIPTION

Introduction

The following terms will be used throughout the specification and will have the following meanings unless otherwise indicated.

The term “zeolite” refers to crystalline aluminosilicate compositions which are microporous and which are formed from corner-sharing AlO₂ and SiO₂ tetrahedra.

The term “framework type” is used in the sense described in the “Atlas of Zeolite Framework Types,” Sixth Revised Edition, Elsevier, 2007.

The term “amorphous” refers to a state in which the material lacks long-range order at the molecular level. Typically such materials do not give distinctive X-ray diffraction patterns. The term “crystalline” refers to a solid phase in which the material has a regular ordered internal structure at the molecular level and gives a distinctive X-ray diffraction pattern with defined peaks.

As used herein, the numbering scheme for the Periodic Table Groups is as disclosed in Chem. Eng. News 1985, 63(5), 26-27.

In preparing aluminosilicate OFF framework type zeolites, a benzyltrimethylammonium cation is used as a structure directing agent (“SDA”), either alone or in combination with an auxiliary organic nitrogen-containing structure directing agent (designated herein as “A”). The structure directing agents (Q and A) are typically associated with anions which can be any anion that is not detrimental to the formation of the zeolite. Representative anions include elements from Group 17 of the Periodic Table (e.g., fluoride, chloride, bromide, and iodide), hydroxide, sulfate, tetrafluoroborate, acetate, carboxylate, and the like.

Reaction Mixture

In general, the crystalline aluminosilicate OFF framework type zeolite is prepared by: (a) preparing a reaction mixture containing (1) an amorphous silica source; (2) an amorphous alumina source; (3) at least one source of potassium; (4) hydroxide ions; (5) benzyltrimethylammonium cations; (6) optionally, an auxiliary organic nitrogen-containing structure directing agent; and (7) water; and (b) subjecting the reaction mixture to crystallization conditions sufficient to form crystals of the zeolite.

The composition of the reaction mixture from which the zeolite is formed, in terms of mole ratios, is identified in Table 1 below:

TABLE 1

| | Broad | Exemplary |
|---|---|---|
| SiO₂/Al₂O₃ | 10 to 100 | 15 to 80 |
| K/SiO₂ | 0.10 to 0.60 | 0.25 to 0.50 |
| (Q + A)/SiO₂ | 0.10 to 0.50 | 0.10 to 0.35 |
| OH/SiO₂ | 0.35 to 1.00 | 0.50 to 0.70 |
| H₂O/SiO₂ | 10 to 50 | 15 to 30 |

wherein Q represents benzyltrimethylammonium cations, and Q>0; A is an auxiliary organic nitrogen-containing structure directing agent, and A≧0.

Suitable sources of silica can include colloidal silica, precipitated silica, alkali metal silicates, tetraalkyl orthosilicates, and the like, as well as combinations thereof.

Suitable sources of alumina can include hydrated alumina, water-soluble aluminum salts such as aluminum nitrate and/or sodium aluminate, and the like, as well as combinations thereof.

Suitable sources of potassium include any potassium salt which is not detrimental to the crystallization of the zeolite, though potassium hydroxide is typically used.

The optional auxiliary nitrogen-containing structure directing agent (A) can be any organic nitrogen-containing compound suitable for synthesizing the offretite type zeolites. Structure directing agents suitable for synthesizing such materials are known in the art (see, for example, U.S. Pat. No. 5,133,951). Exemplary auxiliary structure directing agents include tetramethylammonium cations, (2-hydroxyethyl)trimethylammonium cations, and N,N′-dimethyl-1,4-diazabicyclo[2.2.2]octane dications. The A/Q mole ratio in the reaction mixture can range from 0 to 0.5 (e.g., from 0.01 to 0.5, from 0.01 to 0.4, from 0.01 to 0.3, from 0.01 to 0.2, or from 0.01 to 0.1).

Optionally, the reaction mixture may also include seeds of a zeolite material, such as offretite crystals from a previous synthesis, in an amount of from 0.1 to 10 wt. % (e.g., from 0.5 to 5 wt. %) of the reaction mixture.

For each embodiment described herein, the reaction mixture can be supplied by more than one source. Also, two or more reaction components can be provided by one source. For example, an amorphous aluminosilicate can function as a source of Al₂O₃ and SiO₂. These amorphous materials may sometimes be referred to as silica stabilized aluminas, silica-alumina, acidic silica-alumina, or silica-alumina hyd rates.

The reaction mixture can be prepared either batch wise or continuously. Crystal size, morphology and crystallization time of the crystalline zeolite described herein can vary with the nature of the reaction mixture and the crystallization conditions.

Crystallization and Post-Synthesis Treatment

Crystallization of the zeolite can be carried out under either static, tumbled or stirred conditions in a suitable reactor vessel, such as for example polypropylene jars or Teflon-lined or stainless steel autoclaves, at a temperature of from 125° C. to 200° C. for a time sufficient for crystallization to occur at the temperature used, e.g., from 1 day to 14 days.

Once the zeolite crystals have formed, the solid product is separated from the reaction mixture by standard mechanical separation techniques such as centrifugation or filtration. The crystals are water-washed and then dried to obtain the as-synthesized zeolite crystals. The drying step is typically performed at a temperature of less than 200° C.

As a result of the crystallization process, the recovered crystalline zeolite product contains within its pore structure at least a portion of the structure directing agent used in the synthesis.

The organic structure directing agent is typically at least partially removed from the zeolite by calcination before use. Calcination consists essentially of heating the zeolite comprising the structure directing agent at a temperature of from 200° C. to 800° C. in the presence of an oxygen-containing gas, optionally in the presence of steam. The organic structure directing agent can also be removed by photolysis techniques as described in U.S. Pat. No. 6,960,327.

To the extent desired and depending on the composition of the zeolite, any cations in the as-synthesized or calcined zeolite can be replaced in accordance with techniques well known in the art by ion exchange with other cations. Preferred replacing cations include metal ions, hydrogen ions, hydrogen precursor, e.g., ammonium ions and mixtures thereof. Particularly preferred cations are those which tailor the catalytic activity for certain hydrocarbon conversion reactions. These include hydrogen, rare earth metals and metals of Groups 2 to 15 of the Periodic Table of the Elements. As used herein, the term “as-synthesized” refers to the zeolite in its form after crystallization, prior to removal of the SDA cation.

The zeolite disclosed herein can be formulated with into a catalyst composition by combination with other materials, such as binders and/or matrix materials, which provide additional hardness or catalytic activity to the finished catalyst. When blended with such components, the relative proportions of the zeolite disclosed herein and matrix may vary widely with the OFF framework type zeolite content ranging from 1 to 99 wt. % (e.g., from 10 to 90 wt. % or from 20 to 80 wt. %) of the total catalyst.

Characterization of the Zeolite

In its as-synthesized and anhydrous form, the aluminosilicate OFF framework type zeolites prepared by the method disclosed herein have a chemical composition comprising the following molar relationship:

m(Q+A):Al₂O₃:(n)SiO₂

wherein 0<m≦0.2; Q represents benzyltrimethylammonium cations, and Q>0; A represents an auxiliary organic nitrogen-containing structure directing agent, and A≧0; and n has a value from of 10 to 16 (e.g., from 10 to 15, from 10 to 14, from 11 to 16, from 11 to 15, from 11 to 14, from 11.5 to 16, from 11.5 to 15, from 11.5 to 14, from 12 to 16, from 12 to 15, or from 12 to 14).

It should be noted that the as-synthesized form of the zeolite disclosed herein may have molar ratios different from the molar ratios of reactants of the reaction mixture used to prepare the as-synthesized form. This result may occur due to incomplete incorporation of 100% of the reactants of the reaction mixture into the crystals formed (from the reaction mixture).

In its calcined from, the aluminosilicate OFF framework type zeolites prepared by the method disclosed herein have a chemical composition comprising the following molar relationship:

Al₂O₃:(n)SiO₂

wherein n has a value from of 10 to 16 (e.g., from 10 to 15, from 10 to 14, from 11 to 16, from 11 to 15, from 11 to 14, from 11.5 to 16, from 11.5 to 15, from 11.5 to 14, from 12 to 16, from 12 to 15, or from 12 to 14).

The OFF framework type zeolites synthesized by the process described herein are characterized by their X-ray diffraction pattern. X-ray diffraction patterns representative of OFF framework type zeolites can be referenced in the “Collection of Simulated XRD Powder Patterns for Zeolites,” Fifth Revised Edition, Elsevier, 2007. Minor variations in the diffraction pattern can result from variations in the mole ratios of the framework species of the particular sample due to changes in lattice constants. In addition, sufficiently small crystals will affect the shape and intensity of peaks, leading to significant peak broadening. Minor variations in the diffraction pattern can result from variations in the organic compound used in the preparation. Calcination can also cause minor shifts in the X-ray diffraction pattern. Notwithstanding these minor pertubations, the basic crystal structure remains unchanged.

The powder X-ray diffraction patterns presented herein were collected by standard techniques. The radiation was CuK_{α} radiation. The peak heights and the positions, as a function of 2θ where θ is the Bragg angle, were read from the relative intensities of the peaks, and d, the interplanar spacing corresponding to the recorded lines, can be calculated.

In one embodiment, the OFF framework type zeolite prepared in accordance with this disclosure is preferably substantially free of non-OFF framework type material. By “substantially free of non-OFF framework type material” is meant that the zeolite composition disclosed herein contains less than 2.5% non-OFF framework type character (e.g., less than 1% non-OFF framework type character, less than 0.5% non-OFF framework type character, or no measurable non-OFF framework type character), as measured by X-ray diffraction. The presence of these impurities can be determined and quantified by analysis of the X-ray diffraction pattern of a sample. The term “non-OFF framework type material” used herein means any material that does not contain crystalline zeolite of the OFF framework type. Examples of such non-OFF framework type material include, for example, amorphous material and ERI framework type zeolites.

### EXAMPLES

The following illustrative examples are intended to be non-limiting.

### Example 1

0.42 g of 45% KOH solution, 0.17 g of deionized water and 0.03 g of hydrated alumina (Barcroft 0250) were mixed together in a Teflon liner. Then, 1.39 g of 40% benzyltrimethylammonium hydroxide solution (Sigma-Aldrich) was added to the mixture. Finally, 2 g of colloidal silica (33% SiO₂, Nalco) was added to the mixture and the resulting gel was stirred until became homogeneous. The liner was capped and placed within a Parr steel autoclave reactor. The autoclave was placed in an oven and heated at 150° C. for 4 days. The solid products were recovered from the cooled reactor by centrifugation, washed with deionized water and dried at 95° C.

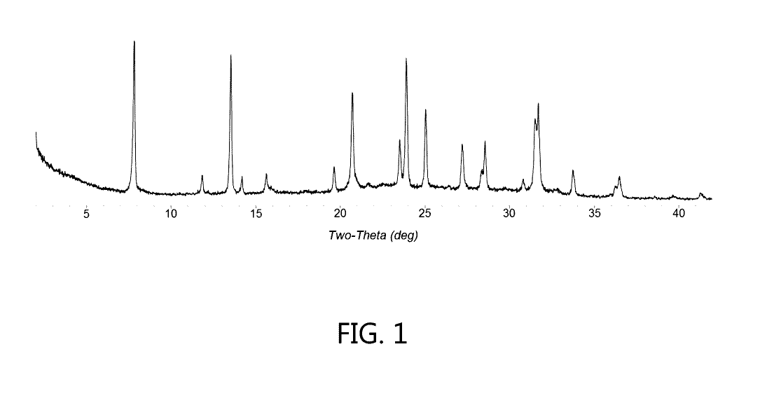

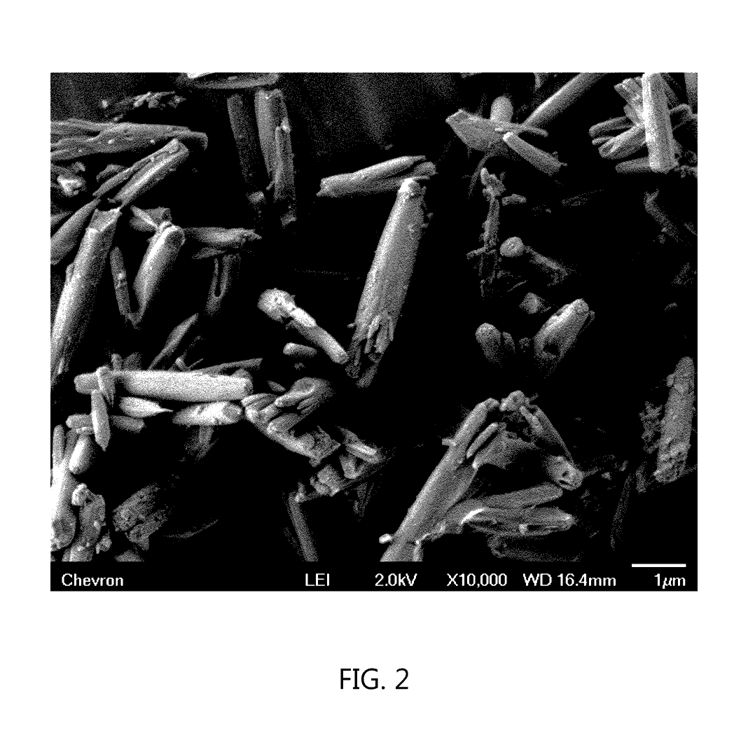

The resulting product was analyzed by powder XRD and SEM. The powder XRD pattern is shown in FIG. 1 and indicates that the material is a pure OFF framework type zeolite. The SEM image is shown in FIG. 2 and indicates a uniform field of crystals.

The product had a SiO₂/Al₂O₃ mole ratio of 13.9, as determined by ICP elemental analysis.

### Example 2

0.82 g of 46% KOH solution, 0.87 g of deionized water, 0.14 g of Reheis F2000 hydrated alumina (53% Al₂O₃, 47% H₂O), 3 g of colloidal silica (LUDOX® AS-30), and 0.94 g of 40% benzyltrimethylammonium hydroxide solution (Sigma-Aldrich) were combined in a 23 mL PEEK liner and then stirred at room temperature for 3 days. The liner was capped and placed within a Parr steel autoclave reactor. The autoclave was placed in an oven and heated at 150° C. under static conditions for 7 days. The solid products were recovered from the cooled reactor by centrifugation, washed with deionized water and dried at 95° C.

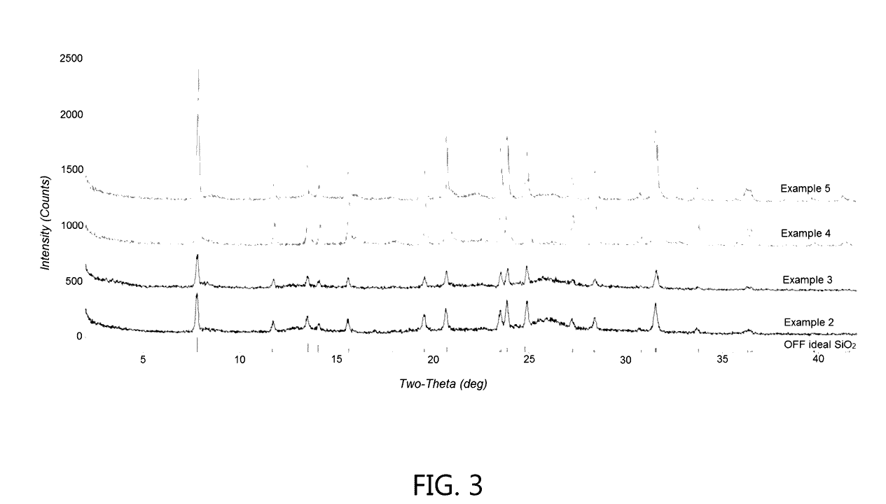

The resulting product was analyzed by powder XRD. The powder XRD pattern is shown in FIG. 3 and indicates that the material is a pure OFF framework type zeolite.

The product had a SiO₂/Al₂O₃ mole ratio of 12.9, as determined by ICP elemental analysis.

### Example 3

0.82 g of 46% KOH solution, 0.90 g of deionized water, 0.10 g of Reheis F2000 hydrated alumina (53% Al₂O₃, 47% H₂O), 3 g of colloidal silica (LUDOX® AS-30), and 0.94 g of 40% benzyltrimethylammonium hydroxide solution (Sigma-Aldrich) were combined in a 23 mL PEEK liner and then stirred at room temperature for 3 days. The liner was capped and placed within a Parr steel autoclave reactor. The autoclave was placed in an oven and heated at 150° C. under static conditions for 7 days. The solid products were recovered from the cooled reactor by centrifugation, washed with deionized water and dried at 95° C.

The resulting product was analyzed by powder XRD. The powder XRD pattern is shown in FIG. 3 and indicates that the material is a pure OFF framework type zeolite.

### Example 4

0.82 g of 46% KOH solution, 0.93 g of deionized water, 0.14 g of Reheis F2000 hydrated alumina (53% Al₂O₃, 47% H₂O), 3 g of colloidal silica (LUDOX® AS-30), 0.85 g of 40% benzyltrimethylammonium hydroxide solution (Sigma-Aldrich), and 0.094 g of 20% N,N′-dimethyl-1,4-diazobicyclo[2.2.2]octane dihydroxide (SACHEM Inc.) were combined in a 23 mL PEEK liner and then stirred at room temperature for 3 days. The liner was capped and placed within a Parr steel autoclave reactor. The autoclave was placed in an oven and heated at 150° C. under static conditions for 7 days. The solid products were recovered from the cooled reactor by centrifugation, washed with deionized water and dried at 95° C.

The resulting product was analyzed by powder XRD. The powder XRD pattern is shown in FIG. 3 and indicates that the material is a pure OFF framework type zeolite.

The product had a SiO₂/Al₂O₃ mole ratio of 11.9, as determined by ICP elemental analysis.

### Example 5

0.82 g of 46% KOH solution, 0.99 g of deionized water, 0.14 g of Reheis F2000 hydrated alumina (53% Al₂O₃, 47% H₂O), 3 g of colloidal silica (LUDOX® AS-30), 0.75 g of 40% benzyltrimethylammonium hydroxide solution (Sigma-Aldrich), and 0.19 g of 20% N,N′-dimethyl-1,4-diazobicyclo[2.2.2]octane dihydroxide (SACHEM Inc.) were combined in a 23 mL PEEK liner and then stirred at room temperature for 3 days. The liner was capped and placed within a Parr steel autoclave reactor. The autoclave was placed in an oven and heated at 150° C. under static conditions for 7 days. The solid products were recovered from the cooled reactor by centrifugation, washed with deionized water and dried at 95° C.

The resulting product was analyzed by powder XRD. The powder XRD pattern is shown in FIG. 3 and indicates that the material is a pure OFF framework type zeolite.

The product had a SiO₂/Al₂O₃ mole ratio of 12.0, as determined by ICP elemental analysis.

### Example 6

The as-synthesized zeolite of Example 1 was calcined in a muffle furnace under a flow of air heated to 540° C. at a rate of 1° C./minute and held at 540° C. for 5 hours, cooled and then analyzed by powder XRD.

The powder XRD pattern indicates that the material remains stable after calcination to remove the organic SDA.

### Example 7

### Micropore Volume Analysis

The calcined material from Example 6 was treated with a 1N ammonium nitrate solution (10 mL/g of zeolite) at 90° C. for 2 hours. The solution was cooled, decanted off and the process repeated.

The ammonium-exchanged zeolite product was subjected to a micropore volume analysis using N₂ as adsorbate and via the BET method. The zeolite exhibited a micropore volume of 0.17 cm³/g.

As used herein, the term “comprising” means including elements or steps that are identified following that term, but any such elements or steps are not exhaustive, and an embodiment can include other elements or steps.

Unless otherwise specified, the recitation of a genus of elements, materials or other components, from which an individual component or mixture of components can be selected, is intended to include all possible sub-generic combinations of the listed components and mixtures thereof.

All documents cited in this application are herein incorporated by reference in their entirety to the extent such disclosure is not inconsistent with this text.

1. A method of preparing an aluminosilicate OFF framework type zeolite, comprising:
(a) preparing a reaction mixture containing:
(1) an amorphous silica source;
(2) an amorphous alumina source;
(3) a source of potassium;
(4) hydroxide ions;
(5) benzyltrimethylammonium cations (Q);
(6) optionally, an auxiliary organic nitrogen-containing structure directing agent (A);
(7) water; and
(b) subjecting the reaction mixture to crystallization condition sufficient to form crystals of the zeolite.

2. The method of claim 1, wherein the zeolite is prepared from a reaction mixture having the following molar composition:

| | |
|---|---|
| SiO₂/Al₂O₃ | 10 to 100 |
| K/SiO₂ | 0.10 to 0.60 |
| (Q + A)/SiO₂ | 0.10 to 0.50 |
| OH/SiO₂ | 0.35 to 1.00 |
| H₂O/SiO₂ | 10 to 50 |

wherein Q>0 and A≧0.

3. The method of claim 1, wherein the zeolite is prepared from a reaction mixture having the following molar composition:

| | |
|---|---|
| SiO₂/Al₂O₃ | 15 to 80 |
| K/SiO₂ | 0.25 to 0.50 |
| (Q + A)/SiO₂ | 0.10 to 0.35 |
| OH/SiO₂ | 0.50 to 0.70 |
| H₂O/SiO₂ | 15 to 30 |

wherein Q>0 and A≧0.

4. The method of claim 1, wherein the amorphous silica source is selected from the group consisting of colloidal silica, precipitated silica, alkali metal silicates, tetraalkyl orthosilicates, and combinations thereof.

5. The method of claim 1, wherein the amorphous alumina source is selected from the group consisting of hydrated alumina, water-soluble aluminum salts, and combinations thereof.

6. The method of claim 1, wherein the auxiliary organic nitrogen-containing structure directing agent (A) is selected from the group consisting of tetramethylammonium cations, (2-hydroxyethyl)trimethylammonium cations, N,N′-dimethyl-1,4-diazabicyclo[2.2.2]octane dications, and combinations thereof.

7. The method of claim 6, wherein the auxiliary organic nitrogen-containing structure directing agent (A) is selected from N,N′-dimethyl-1,4-diazabicyclo[2.2.2]octane dications.

8. The method of claim 1, wherein the zeolite has a chemical composition, in its as-synthesized and anhydrous form, comprising the following molar relationship:
m(Q+A):Al₂O₃:(n)SiO₂
wherein 0<m≦0.2; Q>0; A≧0; and n has a value from 10 to 16.

9. The method of claim 1, wherein the zeolite has a chemical composition, in its as-synthesized and anhydrous form, comprising the following molar relationship:
m(Q+A):Al₂O₃:(n)SiO₂
wherein 0<m≦0.2; Q>0; A≧0; and n has a value from 11.5 to 15.

10. The method of claim 1, wherein the zeolite is substantially free of non-OFF framework type material.
